(19) United States
(12) Patent Application Publication
(10) Pub. No.: US 2022/0111499 A1
(43) Pub. Date: Apr. 14, 2022

(54) SOCKET EXTENDER WITH BIT LOCKING MECHANISM

(71) Applicant: Hershey Tool Corp., Orange, OH (US)

(72) Inventor: Noah Hershey, Orange, OH (US)

(21) Appl. No.: 17/065,603

(22) Filed: Oct. 8, 2020

(51) Int. Cl. B25B 23/00

(52) U.S. Cl. CPC B25B 23/0035; B25B 23/0021

(57) ABSTRACT

A socket extender with a bit locking mechanism is described herein. The socket extender includes a proximal end, a shaft, and a distal end; the shaft extends from the proximal end to the distal end. The proximal end includes a proximal side wall that defines a female square shaped drive socket. The distal end includes a distal sidewall that defines a female hexagon shaped head. The distal end further includes a set screw, where the set screw passes through an opening in the distal sidewall. A point of the set screw is engageable with a bit inserted into the female hexagon shaped head such that the bit is retained in the female hexagon shaped head. Further, at least a portion of the socket extender can be magnetized for bit retention. Moreover, a drive square (of a driving tool) is receivable in the female square shaped drive socket.

### BACKGROUND

Socket extenders enable reaching fasteners (e.g., bolts, screws, etc.) in hard-to-reach locations. Various socket extenders have female hexagon shaped heads; for instance, a bit can be received within a female hexagon shaped head of a socket extender. Many conventional socket extenders utilize magnets to retain bits when positioned within the female hexagon shaped head. However, when driving a fastener, the force of the magnet retaining the bit within the female hexagon shaped head may be overcome, and thus, the bit may withdraw from the female hexagon shaped head. Accordingly, when such a conventional socket extender is utilized and when the socket extender is removed from the fastener, oftentimes the bit will remain in the fastener due to the force of the magnet being overcome. Thus, since the magnet may be overcome due to the bit staying in the fastener, the bit may remain in a hard-to-reach location and may be difficult to retrieve.

Other conventional socket extenders can utilize a press fit attachment to retain a bit within a female hexagon shaped head. However, similar to the use of magnetic retention, a force exerted by the press fit can be overcome, thereby allowing for the bit to remain in a hard-to-reach location or potentially becoming a projectile during free spin.

### SUMMARY

Described herein are various technologies that pertain to socket extenders. A socket extender with a bit locking mechanism can include a proximal end and a distal end with a shaft extending from the proximal end to the distal end. The proximal end can include a proximal side wall that defines a female square shaped drive socket. Further, the distal end can include a distal sidewall that defines a female hexagon shaped head. The distal end can further include a set screw, where the set screw passes through an opening in the distal sidewall. The set screw can be part of the bit locking mechanism of the socket extender.

According to various embodiments, the socket extender can be tapered such that an outer diameter of the proximal end is larger than an outer diameter of the distal end. For instance, the shaft can be tapered, where an outer diameter of the shaft at the proximal end is larger than an outer diameter of the shaft at the distal end. Pursuant to various embodiments, the shaft can include a tapered section and a uniform section; the tapered section can have a first end and a second end, and the uniform section can have a first end and a second end. The first end of the tapered section can be coupled to the proximal end of the socket extender. The second end of the tapered section can be coupled to the first end of the uniform section. Moreover, the second end of the uniform section can be coupled to the distal end of the socket extender. An outer diameter of the shaft can decrease across the tapered section from the first end of the tapered section to the second end of the tapered section. Moreover, an outer diameter of the shaft can be substantially uniform across the uniform section from the first end the uniform section to the second end of the uniform section.

According to various embodiments, a drive square can be inserted into the female square shaped drive socket at the proximal end of the socket extender. Moreover, a bit can be inserted into the female hexagon shaped head at the distal end of the socket extender. The bit inserted into the female hexagon shaped head can be retained by tightening the set screw. For instance, a point of the set screw can be engageable with a bit inserted into the female hexagon shaped head, such that the bit is retained in the female hexagon shaped head. Thus, the set screw can supply sufficient force to cause the bit to remain within the female hexagon shaped head when the bit is engaged with a fastener. By way of illustration, the set screw can supply sufficient force so that the bit remains in the female hexagon shaped head rather than withdrawing from the female hexagon shaped head and staying in the fastener. Moreover, the bit inserted into the female hexagon shaped head can thereafter be released by loosening the set screw.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates various views of an exemplary socket extender with a bit locking mechanism.

FIG. 2 illustrates the socket extender of FIG. 1 being mechanically couplable to a bit.

FIG. 3 illustrates the socket extender of FIG. 1 being mechanically couplable to a drive square of a driving tool.

FIG. 4 illustrates a close-up view of a distal end of the socket extender of FIG. 1.

FIG. 5 illustrates an exemplary method of using the socket extender of FIG. 1.

### DETAILED DESCRIPTION

Various technologies pertaining to a socket extender with a bit locking mechanism are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “first”, “second”, and the like are used for purposes of identification. These terms are not intended to signify any particular ordering.

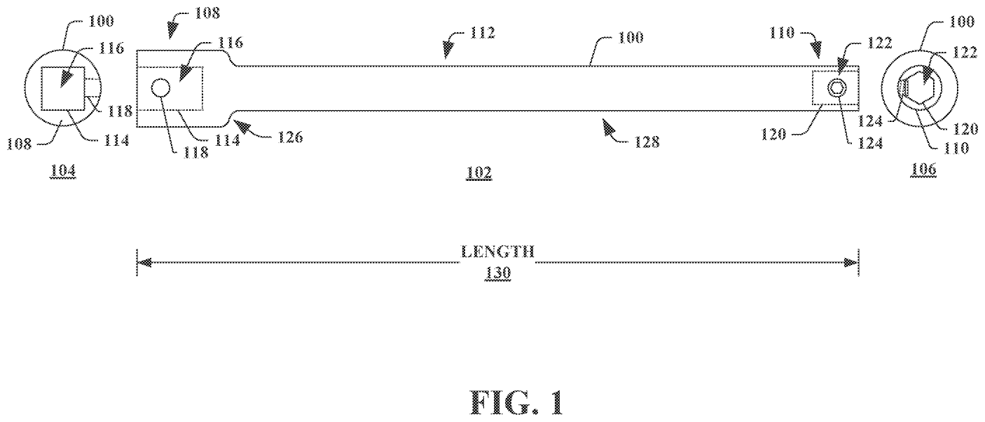

Referring now to the drawings, FIG. 1 illustrates an exemplary socket extender 100. The socket extender 100 is a device that allows for reaching into hard to access locations. For instance, the socket extender 100 can be mechanically couplable to a driving tool that has a male drive square (e.g., a male connection fitting having a square cross-section). Examples of driving tools that can be mechanically couplable to the socket extender 100 include a socket wrench, a pneumatic impact wrench, a hydraulic torque wrench, or the like. Further, a bit can be couplable to the socket extender 100. Thus, when the socket extender 100 is coupled to a driving tool and a bit, the driving tool can be used to rotate the socket extender 100 which in turn rotates the bit. The bit can be engaged with a fastener (e.g., a threaded fastener such as a screw, bolt, etc.); accordingly, the fastener can be rotated by way of the rotational motion of the bit and socket extender caused by the driving tool.

The terms “proximal” and “distal” are used herein. These terms are used in reference to a portion of the socket extender 100 that is couplable to the driving tool. Thus, a proximal end of the socket extender 100 is situated nearer to the driving tool as compared to a distal end when the driving tool is coupled to the socket extender 100.

FIG. 1 depicts various views of the socket extender 100 with a bit locking mechanism. More particularly, a side view of the socket extender 100 is shown at 102, a proximal end view of the socket extender 100 is depicted at 104, and a distal end view of the socket extender 100 is illustrated at 106. The socket extender 100 includes a proximal end 108, a distal end 110, and a shaft 112 extending from the proximal end 108 to the distal end 110. The proximal end 108, the shaft 112, and the distal end 110 are contiguous, forming the socket extender 100.

The proximal end 108 includes a proximal side wall 114 that defines a female square shaped drive socket 116; an interior surface of the proximal side wall 114 defines the female square shaped drive socket 116. Moreover, an exterior surface of the proximal end 108 (e.g., an exterior surface of the proximal side wall 114) can have a circular cross-section. The female square shaped drive socket 116 is a cavity having a square shaped cross-section. The female square shaped drive socket 116 is sized and positioned as part of the proximal end 108 of the socket extender 100 such that a drive square can be inserted into the female square shaped drive socket 116 at the proximal end 108 of the socket extender 100. According to an example, the proximal side wall 114 can define a ½ inch female square shaped drive socket 116. According to another example, the proximal sidewall 114 can define a ⅜ inch female square shaped drive socket 116. Pursuant to a further example, the proximal sidewall 114 can define a ¼ inch female square shaped drive socket 116. The proximal end 108 can further include a side hole 118. The side hole 118 can enable the drive square to be retained within the female square shape drive socket 116.

The distal end 110 of the socket extender 100 includes a distal side wall 120 that defines a female hexagon shaped head 122. An exterior surface of the distal end 110 (e.g., an exterior surface of the distal side wall 120) can have a circular cross-section. An interior surface of the distal side wall 120 defines the female hexagon shaped head 122. The female hexagon shaped head 122 is a cavity having a hexagon shaped cross-section. Further, the female hexagon shaped head 122 is sized and positioned as part of the distal end 110 of the socket extender 100 such that a bit can be inserted into the female hexagon shaped head 122 at the distal end 110 of the socket extender 100.

Moreover, the distal end 110 includes a set screw 124. The set screw 124 passes through an opening in the distal sidewall 120. A point of the set screw 124 can be engageable with a bit inserted into the female hexagon shaped head 122 such that the bit can be retained in the female hexagon shaped head 122 by a force exerted by the point of the set screw 124 onto the bit. The set screw 124 can be part of a bit locking mechanism of the socket extender 100.

The set screw 124 allows for locking a bit in place within the female hexagon shaped head 122. The force exerted by the point of the set screw 124 can be such that the bit will remain in the female hexagon shaped head 122, while conventional magnetic retention or press fit retention approaches may allow for inadvertent removal of a bit (e.g., causing the bit to remain in a hard to reach location, causing the bit to become a projectile, etc.). Moreover, use of the set screw 124 enables a diameter of the socket extender 100 at the distal end 110 to be reduced (compared to conventional approaches that utilize a larger diameter collar to retain a bit); thus, the distal end 110 can have a lower profile to allow for use in narrower locations.

The female hexagon shaped head 122 can be configured to receive a ¼ inch bit, according to various examples. Pursuant to other examples, the female hexagon shaped head 122 can be configured to receive a 5/16 inch bit. It is to be appreciated, however, that the female hexagon shaped head 122 can alternatively be configured to receive bits of other sizes.

It is contemplated that various sizes of set screws are intended to fall within the scope of the hereto appended claims. For example, the set screw 124 can have a length of ⅛ inch. According to another example, the set screw 124 can have a length of 1/16 inch. Moreover, it is to be appreciated that set screws having various types of points are intended to fall within the scope of the hereto appended claims. For instance, the type of the point of the set screw 124 can be one of a cup point, a knurl-grip cup point, a flat point, an oval point, a cone point, or an extended point.

The shaft 112 of the socket extender 100, as noted above, extends from the proximal end 108 to the distal end 110 of the socket extender 100. The shaft 112 can be tapered such that an outer diameter of the shaft 112 at the proximal end 108 is larger than an outer diameter of the shaft 112 at the distal end 110. The shaft 112 can have a tapered section 126 and a uniform section 128. The tapered section 126 can have a first end and a second end. Moreover, the uniform section 128 can have a first end and a second end. A first end of the tapered section 126 can be coupled to the proximal end 108 of the socket extender 100. Moreover, the second end of the tapered section 126 can be coupled to the first end of the uniform section 128. Further, the second end of the uniform section 128 can be coupled to the distal end 110 of the socket extender 100. An outer diameter of the shaft 112 can decrease across the tapered section 126 from the first end of the tapered section 126 to the second end of the tapered section 126. Moreover, an outer diameter of the shaft 112 can be substantially uniform across the uniform section 128 from the first end of the uniform section 128 to the second end of the uniform section 128.

According to an example, the outer diameter of the socket extender 100 at the proximal end 108 can be ½ inch. Pursuant to another example, the outer diameter of the socket extender 100 at the proximal end 108 can be ⅝ inch. Yet, other outer diameters at the proximal end 108 are intended to fall within the scope of the hereto appended claims. Moreover, according to an example, the outer diameter of the socket extender 100 at the distal end 110 can be ⅜ inch. Pursuant to another example, the outer diameter of the socket extender 100 at the distal end 110 can be ½ inch. Moreover, other outer diameters of the socket extender 100 at the distal end 110 are intended to fall within the scope of the hereto appended claims. Further, as noted above, the outer diameter of the socket extender 100 at the proximal end 108 is larger than the outer diameter of the socket extender 100 at the distal end 110.

It is to be appreciated that the socket extender 100 can be formed of various materials. For instance, the socket extender 100 can be formed of steel. According to various examples, the socket extender 100 can be formed of chrome vanadium, chrome molybdenum, chrome vanadium molybdenum, high carbon steel, 8650 steel, S2 steel, or stainless steel. Pursuant to other examples, the socket extender 100 can be formed of a composite material or a non-conductive synthetic material. Yet, it is to be appreciated that other types of materials are intended to fall within the scope of the hereto appended claims. Moreover, it is to be appreciated that a combination of materials can be used to form the socket extender 100.

It is to be appreciated that various lengths of the socket extender 100 are intended to fall within the scope of the hereto appended claims. For example, a length 130 can be in a range of 1 inch to 24 inches. According to another example, the length 130 can be in a range of 5 inches to 12 inches. However, it is contemplated that the claimed subject matter is not so limited, as other lengths 130 can fall within the scope of the claimed subject matter.

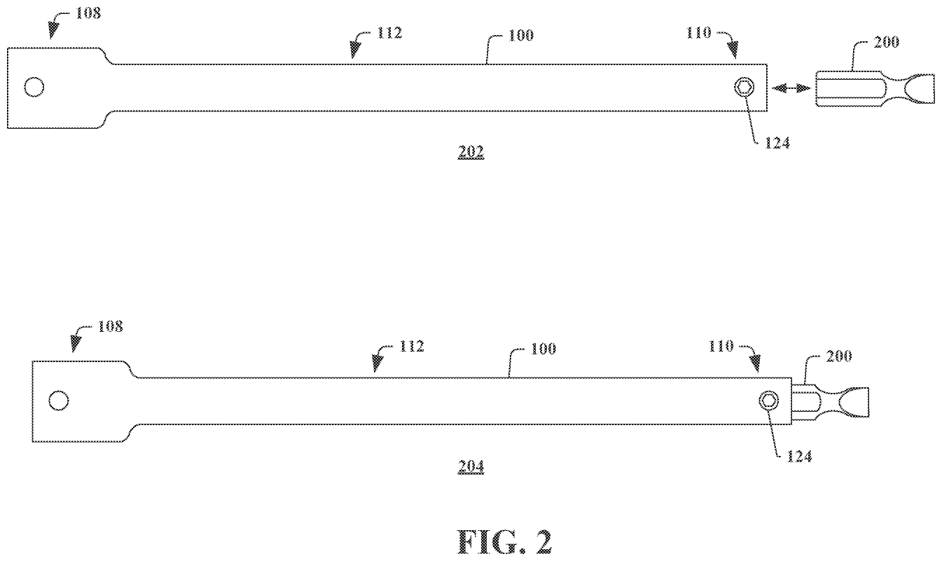

Now turning to FIG. 2, illustrated is the socket extender 100 being mechanically couplable to a bit 200. At 202, the bit 200 is shown as being separate from the socket extender 100. At 204, the bit 200 is shown as being inserted in the female hexagon shaped head 122 of the distal end 110 of the socket extender 100. The set screw 124 can be turned (e.g., utilizing a hex driver or Allen key) to cause the bit 200 to be secured within or removable from the female hexagon shaped head 122. For instance, the bit 200 inserted into the female hexagon shaped head 122 can be retained by tightening the set screw 124 (e.g., to secure the bit 200 within the female hexagon shaped head 122). Moreover, to release the bit 200 inserted into the female hexagon shaped head 122, the set screw 124 can be loosened.

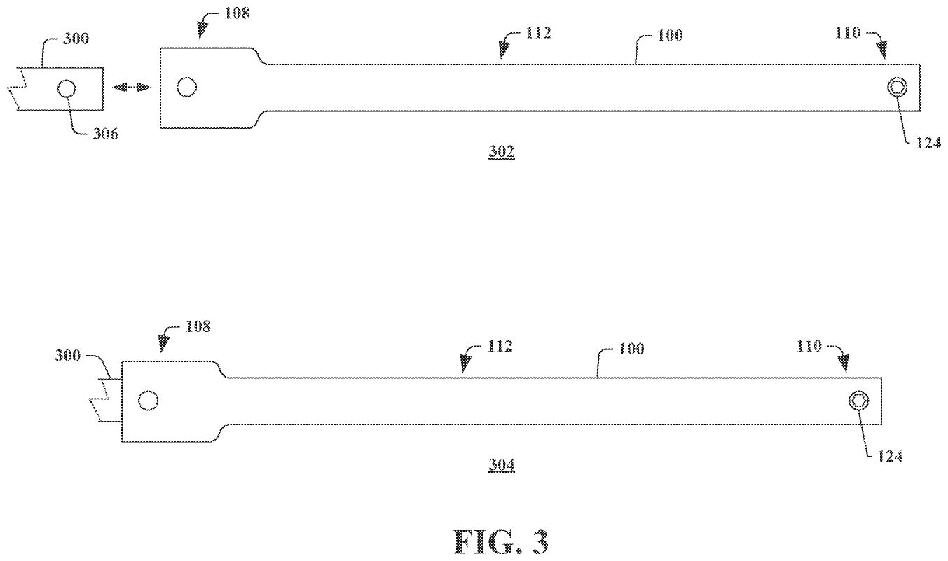

With reference to FIG. 3, depicted is an example of the socket extender 100 being mechanically couplable to a drive square 300 of a driving tool. At 302, the drive square 300 is shown as being separate from the socket extender 100. At 304, the drive square 300 is shown as being inserted into the female square shaped drive socket 116 at the proximal end 108 of the socket extender 100. The drive square 300 is depicted as including a ball 306 that can engage in the side hole 118 of the proximal end 108 of the socket extender 100. When engaged in the side hole 118, the ball 306 can cause the drive square 300 to be retained within the female square shaped drive socket 116. Thus, the ball 306 of the drive square 300 engaged in the side hole 118 of the socket extender 100 can secure the drive square 300 within the female square shaped drive socket 116. When a sufficient pulling force is applied to the drive square 300 (e.g., pulling the drive square 300 out from the female square shaped drive socket 116 of the socket extender 100), the ball 306 can be disengaged from the side hole 118, allowing for separation of the drive square 300 from the socket extender 100.

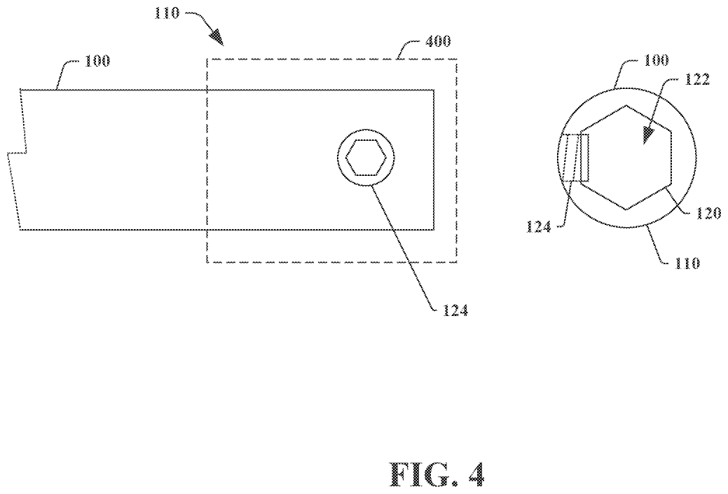

Now turning to FIG. 4 illustrated is a close-up view of the distal end 110 of the socket extender 100. The set screw 124 can be rotated, thereby causing the point of the set screw 124 to move into or out of the female hexagon shaped head 122. As described herein, the set screw 124 can be utilized to secure a bit within the female hexagon shaped head 122.

According to various embodiments, the distal end 110 of the socket extender 100 can be magnetized to retain a bit inserted into the female hexagon shaped head 122 (a magnetized portion of the socket extender 100 is represented by 400 in FIG. 4). Thus, the bits can be retained within the female hexagon shaped head 122 by way of the distal end 110 being magnetized as well as the point of the set screw 124 being engageable with the bit inserted into the female hexagon shaped head 122. Pursuant to other embodiments, it is contemplated that the entire socket extender 100 can be magnetized.

Thus, according to various embodiments, a bit locking mechanism of the socket extender 100 can include the set screw 124 and the magnetization of at least a portion of the distal end 110. Yet, in other embodiments, it is to be appreciated that the socket extender 100 may lack magnetization; hence, the bit locking mechanism of such a socket extender 100 can include the set screw 124 without magnetization.

In accordance with an embodiment where the bit locking mechanism of the socket extender 100 includes the set screw 124 and the magnetization of at least a portion of the distal end 110, it follows that the set screw 124 and the magnetism of the socket extender 100 can provide a dual retention mechanism. For instance, the magnetism can be used to retain the bit inserted into the female hexagon shaped head 122 regardless whether the set screw 124 is tightened to secure the bit. By way of illustration, the bit can be inserted into the female hexagon shaped head 122, and the bit and socket extender 100 can be used to manipulate a fastener (without tightening the set screw 124); in such case, the magnetization of the socket extender 100 can hold the bit in place within the female hexagon shaped head 122. However, according to another illustration, should it be desired to have the bit more securely retained in the female hexagon shaped head 122 of the socket extender 100 (e.g., if the bit is being used to on a fastener in a hard to reach location), then the set screw 124 can be tightened; thus, when tightened, the force exerted by the set screw 124 as well as the magnetization can secure the bit within the female hexagon shaped head 122 of the socket extender 100.

According to an illustration, the magnetization of the socket extender 100 can be provided by way of a magnet positioned within the female hexagon shaped head 122. Following this illustration, the magnet can be attached to or formed as part of a bottom wall within the female hexagon shaped head 122. The bottom wall and an interior surface of a distal side wall (e.g., the interior surface of the distal side wall 120) define the female hexagon shaped head 122. Thus, the magnet at the bottom of the cavity of the female hexagon shaped head 122 can apply a magnetic force to retain a bit inserted into the female hexagon shaped head 122. Yet, it is contemplated that other types and positions of magnets are intended to fall within the scope of the hereto appended claims.

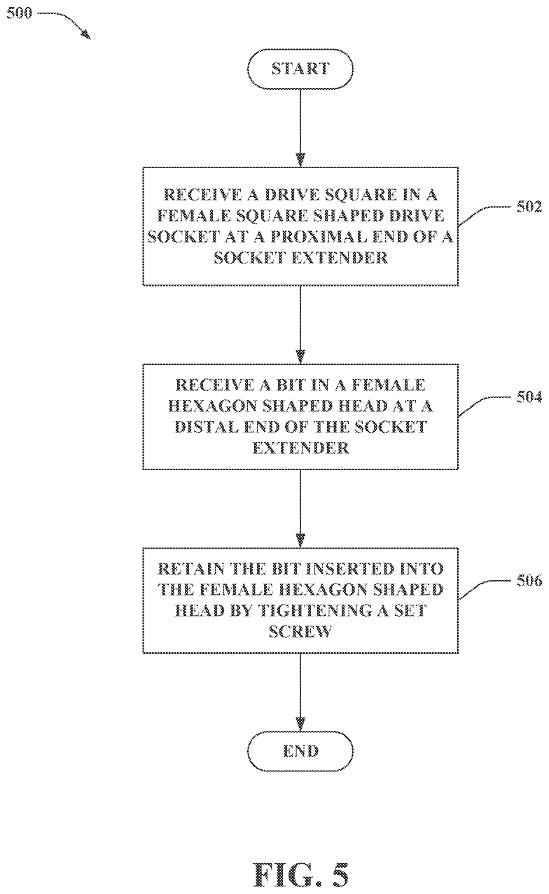

FIG. 5 illustrates an exemplary methodology related to using a socket extender. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement the methodology described herein.

Turning to FIG. 5, illustrated is an exemplary method of using a socket extender 500. At 502, a drive square can be received in a female square shaped drive socket at a proximal end of the socket extender. The proximal end can include a proximal sidewall that defines the female square shaped drive socket. At 504, a bit can be received in a female hexagon shaped head at a distal end of the socket extender. The distal end can include a distal sidewall that defines the female hexagon shaped head. Moreover, a shaft can extend from the proximal end to the distal end of the socket extender. At 506, the bit inserted into the female hexagon shaped head can be retained by tightening a set screw. The set screw can pass through an opening in the distal sidewall of the distal end of the socket extender. Thus, when tightened, the set screw can engage the bit positioned within the female hexagon shaped head. Moreover, the bit inserted into the female hexagon shaped head can be released by loosening the set screw, thereby allow for the bit to be removed from the female hexagon shaped head.

Further, as used herein, the term “exemplary” is intended to mean “serving as an illustration or example of something.”

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A socket extender, comprising:
a proximal end, the proximal end comprises a proximal sidewall that defines a female square shaped drive socket;
a distal end, the distal end comprises:
a distal sidewall that defines a female hexagon shaped head; and
a set screw, the set screw passes through an opening in the distal sidewall; and
a shaft extending from the proximal end to the distal end.

2. The socket extender of claim 1, the shaft being tapered such that an outer diameter of the shaft at the proximal end is larger than an outer diameter of the shaft at the distal end.

3. The socket extender of claim 1, the shaft comprises:
a tapered section having a first end and a second end; and
a uniform section having a first end and a second end;
wherein a first end of the tapered section is coupled to the proximal end of the socket extender, the second end of the tapered section is coupled to the first end of the uniform section, and the second end of the uniform section is coupled to the distal end of the socket extender;
wherein an outer diameter of the shaft decreases across the tapered section from the first end of the tapered section to the second end of the tapered section; and
wherein an outer diameter of the shaft is substantially uniform across the uniform section from the first end of the uniform section to the second end of the uniform section.

4. The socket extender of claim 1, wherein the proximal sidewall defines a ¼ inch female square shaped drive socket.

5. The socket extender of claim 1, wherein the proximal sidewall defines a ⅜ inch female square shaped drive socket.

6. The socket extender of claim 1, wherein the shaft has a length in a range of 1 inch to 24 inches.

7. The socket extender of claim 1 being formed of at least one of a composite material or a non-conductive synthetic material.

8. The socket extender of claim 1 being formed of at least one of chrome vanadium, chrome molybdenum, chrome vanadium molybdenum, high carbon steel, 8650 steel, S2 steel, or stainless steel.

9. The socket extender of claim 1, a point of the set screw being engageable with a bit inserted into the female hexagon shaped head such that the bit is retained in the female hexagon shaped head.

10. The socket extender of claim 9, a type of the point of the set screw being one of a cup point, a knurl-grip cup point, a flat point, an oval point, a cone point, or an extended point.

11. The socket extender of claim 1, the distal end being magnetized to retain a bit inserted into the female hexagon shaped head.

12. The socket extender of claim 1, the set screw having a length of ⅛ inch.

13. The socket extender of claim 1, the set screw having a length of 1/16 inch.

14. The socket extender of claim 1, the female hexagon shaped head configured to receive a ¼ inch bit.

15. The socket extender of claim 1, the female hexagon shaped head configured to receive a 5/16 inch bit.

16. A method of using a socket extender, comprising:
receiving a drive square in a female square shaped drive socket at a proximal end of the socket extender, wherein the proximal end comprises a proximal sidewall that defines the female square shaped drive socket;
receiving a bit in a female hexagon shaped head at a distal end of the socket extender, wherein the distal end comprises a distal sidewall that defines the female hexagon shaped head, and wherein a shaft extends from the proximal end to the distal end; and
retaining the bit inserted into the female hexagon shaped head by tightening a set screw, wherein the set screw passes through an opening in the distal sidewall.

17. The method of claim 16, further comprising:
releasing the bit inserted into the female hexagon shaped head by loosening the set screw.

18. The method of claim 16, wherein the distal end of the socket extender is magnetized to further retain the bit inserted into the female hexagon shaped head.

19. The method of claim 16, wherein the shaft is tapered such that an outer diameter of the proximal end is larger than an outer diameter of the distal end.

20. A socket extender, comprising:
a proximal end, the proximal end comprises a proximal sidewall that defines a female square shaped drive socket;
a distal end, the distal end comprises:
a distal sidewall that defines a female hexagon shaped head; and
a set screw, the set screw passes through an opening in the distal sidewall, a point of the set screw being engageable with a bit inserted into the female hexagon shaped head such that the bit is retained in the female hexagon shaped head; and
a shaft extending from the proximal end to the distal end, the shaft comprises:
a tapered section having a first end and a second end; and
a uniform section having a first end and a second end;
wherein a first end of the tapered section is coupled to the proximal end of the socket extender, the second end of the tapered section is coupled to the first end of the uniform section, and the second end of the uniform section is coupled to the distal end of the socket extender;
wherein an outer diameter of the shaft decreases across the tapered section from the first end of the tapered section to the second end of the tapered section; and
wherein an outer diameter of the shaft is substantially uniform across the uniform section from the first end of the uniform section to the second end of the uniform section.
